(19) United States
(12) Patent Application Publication
(10) Pub. No.: US 2010/0150274 A1
(43) Pub. Date: Jun. 17, 2010

(54) Method and System for Determining a Signal Vector

(75) Inventors: Yongmei Dai, Singapore (SG); Sumei Sun, Singapore (SG); Zhongding Lei, Singapore (SG); Kenichi Higuchi, Kanagawa (JP); Hiroyuki Kawai, Kanagawa (JP)

Correspondence Address: CHOATE, HALL & STEWART LLP, TWO INTERNATIONAL PLACE, BOSTON, MA, 02110, US

(73) Assignees: AGENCY FOR SCIENCE, TECHNOLOGY AND RESEARCH, Centros (SG); NTT DOCOMO, INC., Tokyo (JP)

(21) Appl. No.: 12/299,413

(22) PCT Filed: May 3, 2007
(86) PCT No.: PCT/SG07/00126

§ 371 Date: Oct. 5, 2009

Related U.S. Application Data
(60) Provisional application No. 60/797,509, filed on May 4, 2006.

(51) Int. Cl. H04L 27/06

(52) U.S. Cl. 375/340

(57) ABSTRACT

A method for determining a signal vector comprising a plurality of components from a received signal vector is provided comprising performing a QR decomposition of a channel matrix characterizing the communication channel via which the signal vector was received and being expanded by variance information about the noise on the communication channel carrying out a plurality of determination steps using the QR decomposition of the expanded channel matrix, wherein in each step a set of possible sub-vectors of the signal vector is determined and wherein in each step, the number of possible sub-vectors in the set is lower than a predefined maximum number, and selecting one vector of the set of possible sub-vectors determined in the last step of the plurality of determination steps as the signal vector.

### CROSS-REFERENCE TO RELATED APPLICATIONS

This application claims the benefit of U.S. provisional application 60/797,509 filed 4 May 2006, the entire content of which is incorporated by reference herein for all purposes.

### FIELD OF THE INVENTION

The invention relates to a method and system for determining a signal vector.

### BACKGROUND OF THE INVENTION

Multiple-input and multiple-output (MIMO) systems have been receiving growing attention as a promising candidate for next-generation communication systems due to the fact that the use of multiple transmit and receive antennas dramatically increases the system capacity. As the optimal maximum likelihood (ML) detection incurs an exponential complexity and thus is not suitable for practical use, suboptimal detection algorithms are usually used. However, as an example, the low complexity nulling plus cancellation algorithm (see [1]) suffers from significant diversity loss and power loss.

A lot of efforts have been put into the search for algorithms with low complexity but nearly the performance of maximum likelihood detection, among which sphere decoding (see [2]-[8]) and QR decomposition (QRD) combined with the so-called M-algorithm (QRD-M) [9] are the most appealing ones. Both algorithms are tree-search based algorithms, in which sphere decoding is a depth-first search and QRD-M is a breadth-first search. Sphere decoding reduces complexity by only searching through those candidates falling inside a hypersphere and QRD-M algorithm reduces complexity by only keeping those candidates with smallest accumulated metrics at each step. Although on average sphere decoding has lower complexity than QRD-M algorithm, but its worst-case complexity is significantly higher.

An object of the invention is to provide a detection method with improved performance compared to conventional detection methods.

### SUMMARY OF THE INVENTION

A method for determining a signal vector comprising a plurality of components from a received signal vector is provided that comprises performing a QR decomposition of a channel matrix characterizing the communication channel via which the signal vector was received and being expanded by variance information about the noise on the communication channel, carrying out a plurality of determination steps using the QR decomposition of the expanded channel matrix, wherein in each step a set of possible sub-vectors of the signal vector is determined and wherein in each step, the number of possible sub-vectors in the set is lower than a predefined maximum number, and selecting one vector of the set of possible sub-vectors determined in the last step of the plurality of determination steps as the signal vector.

In other embodiments, a system and a computer program product according to the method for determining a signal vector are provided.

### SHORT DESCRIPTION OF THE FIGURES

Illustrative embodiments of the invention are explained below with reference to the drawings.

FIG. 1 shows a communication system according to an embodiment of the invention.

FIG. 2 shows a flow diagram according to an embodiment of the invention.

### DETAILED DESCRIPTION

Illustratively, in one embodiment, the QRD-M algorithm is carried out for detection but instead of basing it on zero-forcing, it is based on the MMSE (minimum mean squared error) estimate of the signal vector. The near maximum likelihood performance of the QRD-M algorithm may be retained but the overall complexity may be reduced by 50% compared to conventional QRD-M. The QRD-M method based on the MMSE estimate may also be seen as a pre-filtered QRD-M algorithm based on the MMSE filtering principle.

Embodiments which are described in the context of the method for determining a signal vector are analogously valid for the system and computer program product.

The signal vector to be determined is for example sent by a transmitter and the maximum number is lower than the number of all signal vectors that could be sent by the transmitter. The signal vector may also be sent by multiple transmitters, for example according to multiuser MIMO or according to CDMA.

This means that not all possible sub-vectors are taken into account in the determination process which leads to a complexity reduction. When the sub-vectors are determined based on a maximum-likelihood search, this means that the search is not exhaustive.

For example, when for each component of the signal vector a number of possible component values could be sent by the transmitter, the predefined maximum number may be lower than the number of possible component values to the power of the number of components of the signal vector.

In one embodiment, all sub-vectors in a set of possible sub-vectors determined in a step have the same dimension. This is not necessary, however, the sub-vectors may also have different dimensions. The number of determination steps carried out may be the number of components of the signal vector.

In one embodiment, the signal vector is determined using a QRD-M algorithm based on the expanded channel matrix.

The method may further comprise pre-filtering the received signal vector using a MMSE filtering matrix. The sets of sub-vectors may then be determined based on the pre-filtered received vector using an QRD-M algorithm.

As mentioned above, in one embodiment, the minimum mean squared error estimate for the signal vector is determined and the signal vector is determined based on the minimum mean squared estimate using an QRD-M algorithm.

For example, in the first step of the plurality of determination steps, a set of possible symbols for a first component of the signal vector is determined. Furthermore, in each determination step but the first, the set of sub-vectors may be determined based on the set of sub-vectors in the previous step.

In one embodiment, in each step but the first step, the dimensions of the sub-vectors of the set of sub-vectors are larger by one than the dimensions of the sub-vectors of the set of sub-vectors determined in the previous step.

In one embodiment, in each step but the first step, each sub-vector of the set of sub-vectors is a sub-vector of the set of sub-vectors determined in the previous step expanded by one possible symbol for a component of the signal vector for which the sub-vectors in the previous step do not comprise a possible symbol.

In one embodiment, the order of the components of the signal vector according to which the sub-vectors are expanded from step to step is based on the matrix R of the QR decomposition, the column norm or the row norm of the expanded channel matrix or based on post-filtering signal to noise ratio.

The signal vector is for example sent using a plurality of sending antennas and is for example received by a plurality of receiving antennas. Each component of the channel matrix may characterize the channel gain from one of the sending antennas to one of the receiving antennas.

A circuit used in the embodiments of the invention, e.g. in the receiver, can be a hardware circuit designed for the respective functionality or also a programmable unit, such as a processor, programmed for the respective functionality.

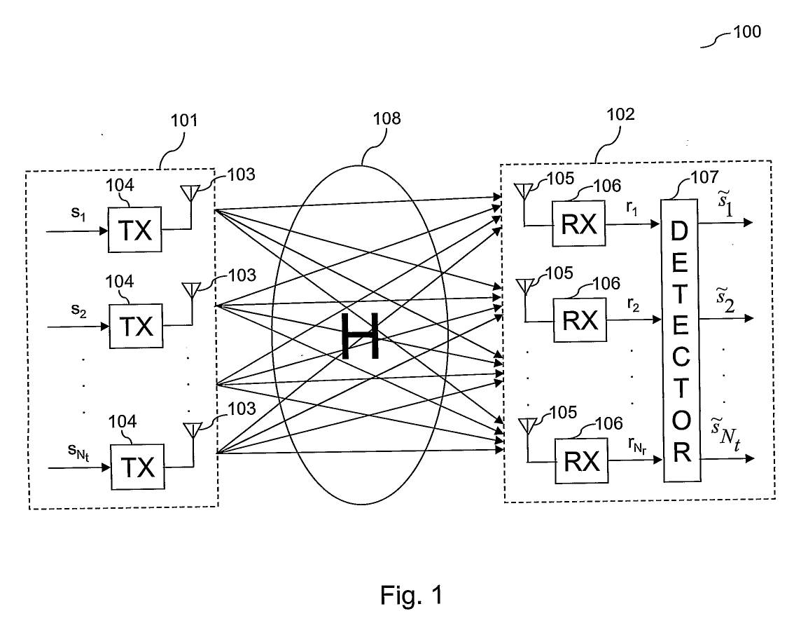

FIG. 1 shows a communication system 100 according to an embodiment of the invention.

The communication system 100 comprises a transmitter 101 and a receiver 102. The transmitter 101 comprises a plurality of transmit antennas 103, each transmit antenna 103 being coupled with a respective sending unit 104.

Each sending unit 104 is supplied with a component of a signal vector s=[s₁, s₂, . . . s_{N}_{ₜ}]^{T} where Nₜ is the number of transmit antennas 103. Each sending unit 104 transmits the respective component of the signal vector s using the respective antenna 103, such that altogether, the signal vector s is sent. The transmitted signal vector is received by the transmitter 102 by a plurality of receive antennas 105, each receive antenna 105 being coupled with a respective receiving unit 106 in form of the received signal vector r=[r₁, r₂, . . . , r_{N}_{ᵣ}]^{T} via a communication channel 108 (the T denotes transposition). Nᵣ denotes the number of receive antennas 105, wherein Nₜ≦Nᵣ.

Since Nᵣ and Nₜ are assumed to be both bigger than one, the communication system 100 is a MIMO (multiple input multiple output) system, for example a MIMO-OFDM (orthogonal frequency division multiplexing) system with Nₜ=Nᵣ=4 or 8 and working at a centre frequency of 5 GHz with a system bandwidth of 20 MHz. Modulation is for example done according to QPSK (quadrature phase shift keying) or 16 QAM (quadrature amplitude modulation). The transmitter 101 may also comprise a circuit for turbo coding (e.g. according to 3GPP) the data to be sent and may comprise a bit interleaver. For modulation, gray mapping may be used. The receiver 102 carries out the respective inverse operations, for example bit de-interleaving and turbo decoding.

Each receive antenna 105 receives one component of the received signal vector r and the respective component is output by the receiving unit 106 coupled to the antenna and fed to a detector 107.

The communication channel 108 is assumed to be a quasi-static flat fading channel. The transmission characteristics of the communication channel 108 between the transmit antennas 103 and the receive antennas 105 can be modelled by a complex channel matrix H. The component H_{j,i} of H characterizes the path gain from the ith transmit antenna 103 to the jth receive antenna 105. It is assumed that the channel matrix H is known to the receiver 102 for example by channel estimation carried out before transmitting the signal vector s.

The received signal vector r can be written as

r=H·s+η (1)

where η=[η₁, η₂, . . . η_{N}_{ᵣ}]^{T} is a vector the jth component of which represents additive white Gaussian noise (AWGN) with variance Nₒ at the jth receive antenna.

The communication system 100 may for example be formed according to the V-BLAST architecture.

The signal vector s is generated from a single data stream that is de-multiplexed in the transmitter 101 into Nₜ sub-streams. Each sub-stream is encoded into symbols and one symbol of a sub-stream corresponds to a component of the signal vector s.

The detector 107 uses the received signal vector r to generate an estimated signal vector \tilde{s} which is an estimate for the originally sent signal vector s.

In the following, some detection methods are described which could be used by the detector 107 to determine the estimated signal vector \tilde{s}.

The estimate \tilde{s} may be determined as the solution of Maximum likelihood detection given by

$${\hat{\underline{s}}}_{MLD} = arg {min}_{\underline{s} ∈ {Ω}^{Nt}} {‖ \underline{r} - \underline{H} \underline{s} ‖}^{2} \qquad ( 2 )$$

where Ω denotes the modulation size, i.e., sᵢ ε Ω for all i.

According to maximum likelihood detection, an exhaustive search is carried out over |Ω|^{Nt} candidate vectors for ŝ_{MLD}. The complexity is therefore high.

Applying QR decomposition to H such that H=QR, where Q is an orthonormal matrix and R is an upper triangular matrix with R_{i,j} , j≧i are its non-zero elements and R_{i,i} is a positive real number for each i, and assuming Nᵣ≧Nₜ, equation (2) may be reformulated:

$${\hat{\underline{s}}}_{MLD} = arg {min}_{\underline{s} ∈ {Ω}^{Nt}} {‖ \underline{y} - R \underline{s} ‖}^{2} \\ = arg {min}_{\underline{s} ∈ {Ω}^{Nt}} \{ {\sum }_{j = 1}^{{N}_{t}} {\vert {y}_{j} - {\sum }_{i = j}^{{N}_{t}} {R}_{j , i} {s}_{i} \vert}^{2} + {\sum }_{k = {N}_{t} + 1}^{{N}_{r}} {\vert {y}_{k} \vert}^{2} \} \\ = arg {min}_{\underline{s} ∈ {Ω}^{Nt}} \{ {‖ \underline{R} ( \hat{\underline{s}} - \underline{s} ) ‖}^{2} + {‖ ( \underline{I} - \underline{R} {\underline{R}}^{†} ) \underline{y} ‖}^{2} \} \\ = arg {min}_{\underline{s} ∈ {Ω}^{Nt}} \{ {\sum }_{j = 1}^{{N}_{t}} {\vert \begin{matrix}{R}_{j , j} ( {\hat{s}}_{j} - {s}_{j} ) + \\ {\sum }_{i = j + 1}^{{N}_{t}} {R}_{j , i} ( {\hat{s}}_{i} - {s}_{i} )\end{matrix} \vert}^{2} + {\sum }_{k = {N}_{t} - 1}^{{N}_{r}} {\vert {y}_{k} \vert}^{2} \} \qquad ( 3 )$$

where y=Q^{H}r and ŝ=H^{†}r=R⁵⁵⁴y is the zero-forcing solution and † indicates the pseudo-inverse of the respective matrix. It can be seen that the second term is independent of the transmitted signal vector s and can therefore be ignored in the minimisation process.

The exhaustive search which may lead to very high complexity can be avoided by using sphere decoding for detection.

A sphere decoder only examines those points falling inside a hypersphere with radius d as candidate vectors for the estimation ŝ, i.e. those vectors s which fulfil

$${\sum }_{j = 1}^{{N}_{t}} {\vert {R}_{j , j} ( {\hat{s}}_{j} - {s}_{j} ) + {\sum }_{i = j + 1}^{{N}_{t}} {R}_{j , i} ( {\hat{s}}_{i} - {s}_{i} ) \vert}^{2} \leq {d}^{2} . \qquad ( 4 )$$

To tell which points s are inside a hypersphere, a more and more stringent necessary condition is applied in sphere detection at each step, e.g., at a first step,

|R_{Nt,Nt}(ŝ_{Nt}−s_{Nt})|²≦d²

is used to find the component \tilde{s}_{Nt} of a vector in the hypersphere, at the second step,

|R_{Nt,Nt}(ŝ_{Nt}−s_{Nt})|²+|R_{Nt-1,Nt-1}(ŝ_{Nt-1}−s_{Nt-1})+R_{Nt-1,Nt}(ŝ_{Nt}−s_{Nt})|²d²

is used to find the component \tilde{s}_{Nt-1} given \tilde{s}_{Nt}. Proceeding in this fashion, all the points can be found eventually as is shown in [5] and [7].

By sphere decoding, the Nₜ-dimensional joint search is reduced to Nₜ one-dimensional search, with a later stage being correlated to all the previous stages, which is essentially a depth-first tree search. Once one point inside the hypersphere is found, the radius is immediately reduced to the new smaller value and the search process is performed again until the maximum likelihood estimate is found.

The complexity of sphere decoding heavily depends on the choice of the initial radius d. If d is chosen too large, too many points are found and if it is too small, no points are found and the radius has to be increased and the search has to be repeated. As suggested in [7], following rule can be used to obtain a value for d,

∥r−Hs∥²=∥η∥²≈NₒE{χ₂ₙ_{ᵣ}²}=NₒNᵣ≦d² (5)

where E{·} denotes the expectation operation. Therefore, d can be chosen based on d²=KNₒNᵣ where K≧1 is a scaling factor. By trial and error, a good K can be found.

The sphere decoder is guaranteed to achieve ML performance (i.e. guaranteed to find the optimal maximum likelihood solution) if the radius is increased when no points inside the specified hypersphere are found, at the cost of higher complexity though. To reduce the complexity without compromising the ML performance, some ordering schemes may be applied:
Ordering based on branch metric: One drawback of sphere decoder is that its complexity highly depends on the choice of initial radius. The ordering scheme proposed in [4] not only reduces the complexity but also makes the complexity insensitive to the initial radius. The new algorithm always starts the search from the constellation point with the smallest branch metric, e.g., at the first step, the s_{Nt} minimizing

|R_{Nt,Nt}(ŝ_{Nt}−s_{Nt})|²
is chosen first and at the second step, s_{Nt-1} minimizing

|R_{Nt-1,Nt-1}(ŝ_{Nt-1}−s_{Nt-1})+R_{Nt-1,Nt}(ŝ_{Nt}−s_{Nt})|²
is chosen first given s_{Nt} and so on. If the channel is well conditioned, the first point found by this algorithm is more likely to be the maximum likelihood estimate. Thus the expected complexity can be greatly reduced.
Ordering based on R: The diagonal elements of R may be maximised to reduce the number of points falling inside the specified sphere at each step and therefore to reduce the complexity. For example, at the first step,

|R_{Nt,Nt}(ŝ_{Nt}−s_{Nt})|²≦d²
is used to find all the s_{Nt}. When R_{Nt,Nt} is larger, then less s_{Nt} will be found for a fixed d. It is more important to maximize R_{j,j} than R_{i,i} provided that j>i since the complexity saving is more significant at upper levels of the tree search. Therefore, if R_{j,j} is lexicographically ordered (DiagR ordering) from smallest to largest for j=1 to j=Nₜ, more complexity saving can be expected. This ordering can be combined with the ordering based on branch metric to get further complexity reduction.
Ordering based on H: The searching process of sphere decoding involves interference cancellation. In interference cancellation based detection methods, detecting the strongest signals first gives more reliable results and leads to a better performance. Therefore, all the ordering schemes previously used in V-BLAST detection may be directly applied for sphere decoding, which are ordering based on the column norm of H (H-norm ordering), ordering based on the row norm of H⁵⁵⁴ (Hinv ordering), and V-BLAST ordering (see [1]). This ordering can also be combined with the ordering based on branch metric.

In one embodiment, the detector 107 determines \tilde{s} according to the QRD-M algorithm (see [9]). The QRD-M algorithm keeps, to minimize the metric in equation (3), only M branches at each step with the smallest accumulated metric. This means that only for M candidate vectors for \tilde{s}, the components (determined so far) are taken into account in the following step. This means that after each step (i.e. after each step of determining a further possible component \tilde{s}) only M vectors are kept as being sub-vectors of \tilde{s}.

For example, at the first step, only M out of Ω possible s_{Nt} with smallest |R_{Nt,Nt}(ŝ_{Nt}−s_{Nt})|² are stored. At the second step, only M out of MΩ combinations (the M stored possibilities for s_{Nt-1} from the first step times Ω possibilities for s_{Nt}) of s_{Nt-1} and s_{Nt} with the smallest accumulated metric |R_{Nt,Nt}(ŝ_{Nt}−s_{Nt})|²+|R_{Nt-1,Nt-1}(ŝ_{Nt-1}−s_{Nt-1})+R_{Nt,Nt-1}(ŝ_{Nt}−s_{Nt})|² are stored and so on. At the last step, the s with smallest overall metric is chosen as the maximum likelihood estimate. This maximum likelihood may not be the optimal one found by an exhaustive search. Consequently, the QRD-M algorithm is a sub-optimal detector in nature and only when M=Ω^{Nt}, it becomes an exhaustive maximum likelihood search. When M=1, it is essentially zero-forcing detection with interference cancellation.

An advantage of the QRD-M algorithm over sphere decoding is that its complexity is fixed when M is fixed. For sphere decoding, the best-case and worst case complexity may differ a lot. However, the overall expected complexity may still be lower than that of the QRD-M algorithm.

The ordering described above for sphere decoding except for the ordering based on the branch metric may also be used when the QRD-M algorithm is used for detection to improve the system performance. The ordering based on the column norm of H is for example applied in the standard QRD-M algorithm described in [9].

For sphere decoding, the expected complexity of most communication systems is O(Nₜ³) (see [5]). The number of nodes searched may be used as an indication of the complexity or to be more accurate, the number of real multiplications performed based on (3) may be used. It may be assumed that the complexity of testing whether one point is inside a sphere or not is negligible. Moreover, the manipulation on the channel matrix may also be considered as being negligible in the calculation of the complexity. Note that R_{j,i} is real when j=i and complex when j≠i.

For coded systems the working SNR is for example set as 7 dB. When the SNR increases the complexity typically decreases. It can be seen from simulations that ordering based on the branch metric (see [4]) has the most significant effect on the complexity, which becomes insensitive to the initial radius. While for those orderings that do not take into consideration the metric, the complexity surges as the radius increases. The H-norm ordering and DiagR ordering can help to reduce the complexity a little bit provided that initial radius is chosen properly.

When the initial radius is too large, their complexities are even higher than the case without ordering. Ordering based on DiagR always leads to a lower complexity than ordering based on H-norm. The mean complexity of the ordering metric algorithm is reduced by around 25% when combined with ordering DiagR or H-norm.

For a 16 QAM modulated 4×4 system, for example, in terms of mean number of nodes searched and mean number of real multiplications performed, respectively, with the working SNR being,set as 15 dB it can be seen that for a large range of the initial radius, the H-norm ordering and DiagR ordering lead to a lower complexity than the case without ordering. When the dimension increases, e.g. for a 8×8 system, the complexity reduction may become more significant when ordering is applied.

The maximum complexity between sphere decoding without ordering, with branch metric ordering and branch metric ordering may differ a lot in practical cases.

In tables 1 and 2, a summarization of a study on the complexity comparison among the maximum likelihood achieving schemes for QPSK and 16 QAM modulated 4×4 systems, respectively, is given. For sphere decoding, metric ordering combined with H-norm ordering is used as reference since this ordering will not introduce too much complexity as opposed to DiagR ordering. For QRD-M algorithm, to achieve ML performance, M=4 is used for QPSK and M=16 is used for 16 QAM. Note that this comparison is meant for hard decision ML only.

TABLE 1
Complexity comparison for QPSK modulated 4 × 4 system

| | | max number | | max |
|---|---|---|---|---|
| | mean number | of | | number |
| | of real | real | mean number | of |
| | multiplications | multiplications | of nodes | nodes |
| ML | 2272 | 2272 | 85 | 85 |
| | | | (1 + 4 + 16 + 64) | |
| QRD-M | 304 | 304 | 13 | 13 |
| (M = 4) | | | (1 + 4 + 4 + 4) | |
| Sphere | 150 | 2052 | 14 | 151 |
| decoder | | | | |

TABLE 2
Complexity comparison for 16QAM modulated 4 × 4 system

| | mean | max number | | max |
|---|---|---|---|---|
| | number of | of real | | number |
| | real | multiplica- | mean number of | of |
| | multiplications | tions | nodes | nodes |
| ML | 330880 | 330880 | 4369 | 4396 |
| | | | (1 + 4 + 256 + 4096) | |
| QRD-M | 3520 | 3520 | 49 | 49 |
| (M = 4) | | | (1 + 16 + 16 + 16) | |
| Sphere | 200 | 8248 | 19 | 676 |
| decoder | | | | |

It can be seen from Tables 1 and 2 that sphere decoding always has the lowest average complexity and its advantage is more obvious for 16 QAM modulation because the complexity of sphere decoding is not so sensitive to the modulation size as opposed to the QRD-M and true ML detections. The problem of sphere decoder is that its worst case complexity is significantly higher than its average complexity. One way to alleviate this problem is to simply limit the upper bound of the complexity. If there is no point found, it is assumed that the zero-forcing solution is the ML estimate. This, however, will bring degradation to the system.

The QRD-M algorithm as described above may be considered as computing the branch metric values based on the zero forcing solution. Since the zero-forcing algorithm is susdeptible to noise enhancement especially when the channel matrix (and hence the corresponding upper triangular matrix in the QR decomposition) is ill conditioned, in one embodiment, a QRD-M algorithm is used for detection which is based on the pseudo-inverse MMSE (minimum mean squared error) algorithm. In one embodiment, this is an application of the pseudo-inverse MMSE algorithm proposed by Hassibi in [10] for MMSE VBLAST nulling and cancellation detection.

Since MMSE is better than zero-forcing algorithm in dealing with the bad channel effect, the performance of the worst branch can be expected to be improved by using this method. Consequently, the number of branches can be reduced in order to achieve the same level of BER performance.

As above, the signal model is expressed as

r=H·s+η (6)

The standard MMSE filtering matrix can be written as

W^{H}=H^{H}(H^{H}+NₒI)⁻¹=(H^{H}H+NₒI)⁻¹H^{H}.

The channel matrix is expanded using variance information about the noise as

$$\underline{G} = [ \begin{matrix}\underline{H} \\ \sqrt{{N}_{O}} \underline{I}\end{matrix} ] ,$$

where I is the Nₜ×Nₜ identity matrix. Further, let

$$\underline{\tilde{y}} = [ \begin{matrix}\underline{r} \\ \underline{O}\end{matrix} ] ,$$

where O is a Nₜ×1 zero column vector. Then G^{†}\tilde{y}=W^{H}r. The ML detection problem can then be written as

$${\underline{\tilde{s}}}_{ml} = arg {min}_{\underline{s} ∈ {Ω}^{Nt}} {‖ \underline{r} - \underline{H} \underline{s} ‖}^{2} \\ = arg {min}_{\underline{s} ∈ {Ω}^{Nt}} \{ {‖ \underline{\tilde{y}} - \underline{G} \underline{s} ‖}^{2} - {N}_{O} {‖ \underline{s} ‖}^{2} \} \\ = arg {min}_{\underline{s} ∈ {Ω}^{Nt}} \{ {‖ G ( \underline{\breve{s}} - \underline{s} ) ‖}^{2} - {N}_{O} {‖ \underline{s} ‖}^{2} + {‖ ( \underline{I} - \underline{G} {\underline{G}}^{†} ) \underline{\tilde{y}} ‖}^{2} \} \\ = arg {min}_{\underline{s} ∈ {Ω}^{Nt}} \{ {\sum }_{j = 1}^{{N}_{t}} {\vert \begin{matrix}{\tilde{R}}_{j , j} ( {\breve{s}}_{j} - {s}_{j} ) + \\ {\sum }_{i = j + 1}^{{N}_{t}} {\tilde{R}}_{j , i} ( {\breve{s}}_{i} - {s}_{i} )\end{matrix} \vert}^{2} - {N}_{O} {‖ \underline{s} ‖}^{2} + {\sum }_{k = {N}_{t} - 1}^{{N}_{r}} {\vert {y}_{k} \vert}^{2} \} \qquad ( 7 )$$

where \tilde{R}=\tilde{Q}^{H}\tilde{G} with \tilde{R}_{i,j} denoting the components of R and \tilde{s}=G^{†}\tilde{y}=W^{H}r is the MMSE estimate. The search process can be done in the same way as in sphere decoding or QRD-M algorithm, except that there is one more term Nₒ∥s∥² participating the search process. For QPSK, for example, it is a constant and can be ignored in the search process.

From simulations it can be seen that pseudo-inverse MMSE based QRD-M with M=4 and H-norm ordering is able to achieve similar performance to the conventional zero-forcing based QRD-M with M=8 and V-BLAST ordering. When V-BLAST ordering is applied, its performance almost reaches ML performance and it outperforms its zero-forcing based counterpart by about 10 dB.

The pre-filtered QRD-M detection scheme can be applied to the Orthogonal Frequency and Code Division Multiplexing (OFCDM) MIMO System (cf. [11]).

The pre-filtered QRD-M detection scheme, i.e. the QRD-M detection method based on the MMSE estimation, may be applied to a MIMO system as shown in FIG. 1, for example a OFCDM (orthogonal frequency and code division) MIMO system but may also be used by a receiver of a GSTBC (groupwise space-time block coded) GSTBC system, e.g. a GSTBC-OFDM system or a GSTBC OFCDM system (cf. [12]).

The pre-filtered QRD-M detection scheme described may also be used for detection in a base station of a multi-user code division multiple access (CDMA) system. The corresponding signal model can in this case be written as:

r=R d+η, (8)

where r=(r₁,R₂, . . . , r_{K})^{T} and rⱼ denotes the jth spreading code matched filter output, R denotes the correlation matrix of the K active users, d denotes the transmitted signal vector, and η denotes the code sequence filtered AWGN noise. The filtered noise is no longer AWGN when the spreading codes of the users are not orthogonal.

The channel gain and the multipath effects for the various users are all incorporated into the correlation matrix R.

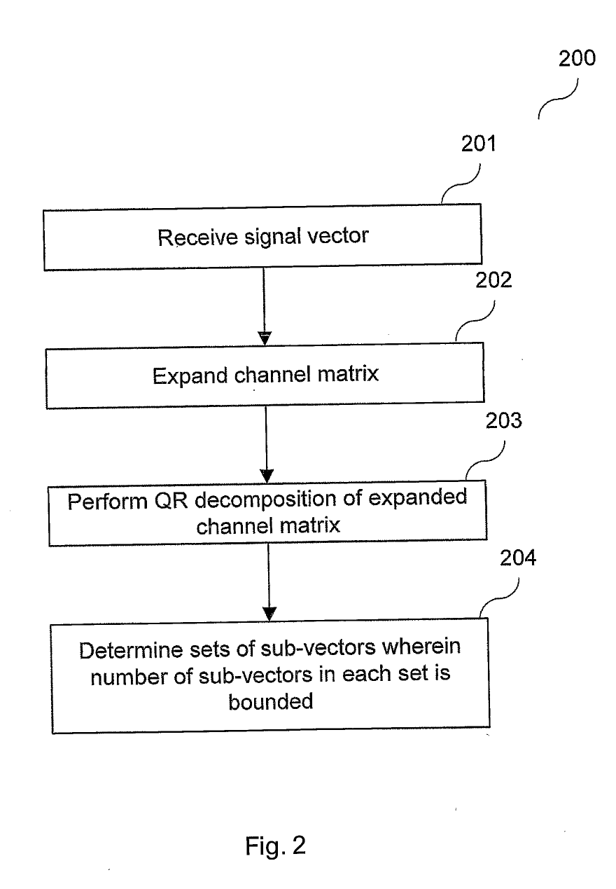

A detection method according to an embodiment of the invention is described with reference to FIG. 2 in the following.

FIG. 2 shows a flow diagram according to an embodiment of the invention.

In 201, a signal vector is received, for example by the receiver of a MIMO system.

It is assumed that the channel via which the signal vector has been received can be characterized by a channel matrix.

In 202, the channel matrix is expanded by variance information about the noise on the communication channel. For example, with the notations used above, the matrix G is generated from the channel matrix H according to G=

$$\underline{G} = [ \begin{matrix}\underline{H} \\ \sqrt{{N}_{O}} \underline{I}\end{matrix} ]$$

where, as above, Nₒ denotes the variance of the noise on the communication channel.

In 203, a QR decomposition of the expanded channel matrix is carried out.

In 204, a plurality of determination steps are carried using the QR decomposition of the expanded channel matrix, wherein in each step a set of possible sub-vectors of the signal vector is determined and wherein in each step, the number of possible sub-vectors in the set is lower than a predefined maximum number. After the last determination step, one vector of the set of possible sub-vectors determined in the last determination step is selected as the signal vector.

The plurality of determination steps are for example carried out according to the QRD-M algorithm.

If the channel characteristics do not rapidly change, a plurality of signal vectors may be determined using the same expanded channel matrix and the same QR decomposition.

Further, the MMSE-based QRD-M scheme may be combined with the adaptive trellis extension scheme described in [11] to reduce the computational complexity.

In this document, the following publications are cited:
[1] P. W. Wolniansky, G. J. Foschini, G. D. Golden and R. A. Valenzuela, “V-BLAST: An architecture for realizing very high data rates over the rich-scattering wireless channel,” in IEEE ISSSE-98, (Pisa, Italy), pp. 295-300, September 1998.
[2] E. Viterbo and J. Boutros, “A Universal Lattice Decoder for Fading Channels,” IEEE Trans. Inform. Theory, vol. 45, no. 5, pp. 1639-1642, July 1999.
[3] Oussama Damen, Ammar Chkeif and Jean-Claude Belfiore, “Lattice Code Decoder for Space Time Codes,” IEEE Commun. Lett., vol. 4, no. 5, pp. 161-163, May 2000.
[4] Albert M. Chan and Inkyu Lee, “A New Reduced-Complexity Sphere Decoder for Multiple Antenna Systems,” IEEE International Conference on Communications, vol. 1, pp. 460-464, May 2002.
[5] Babak Hassibi and Haris Vikalo, “On the expected complexity of integer least-squares problems,” IEEE International Conference on Acoustics, Speech and Signal Processing, vol. 2, pp. 1497 -1500, 2002.
[6] Erik Agrell, Thomas Eriksson, Alexander Vardy and Kenneth Zeger, “Cloest Point Search in Lattices,” IEEE Trans. Inform. Theory, vol. 48, no. 8, pp. 2201-2214, Aug. 2002.
[7] Bertrand M. Hochwald, Stephan ten Brink, “Achieving Near-Capacity on a Multiple-Antenna Channel,” IEEE Trans. Commun., vol. 51, no. 3, pp. 389-399, March 2003.
[8] Mohamed Oussama Damen, Hesham El Gamal and Giuseppe Caire, “On Maximum-Likelihood Detection and the Search for the Closest Lattice Point,” IEEE Trans. Inform. Theory, vol. 49, no. 10, pp. 2389-2402, October 2003.
[9] Kyeong Jin Kim and Ronald A. Iltis, “Joint Detection and Channel Estimation Algorithms for QSCDMA Signals Over Time-Varying Channels,” IEEE Trans. Commun., vol. 50, no. 5, pp. 845-855, May 2002.
[10] Babak Hassibi, “An Efficient Square-Root Algorithm for BLAST,” IEEE International Conference on Acoustics, Speech and Signal Processing, vol. 2, pp. 737-740, June 2000.
[11] Kenichi Higuchi, Hiroyuki Kawai, Noriyuki Maeda, and Mamoru Sawahashi, “Adaptive Selection of Surviving Symbol Replica Candidates Based on Maximum Reliability in QRM-MLD for OFCDM MIMO Multiplexing,” in Global Telecoomunications Conference, vol. 4, pp. 2480-2486, 2004.
[12] Sumei Sun, Yan Wu, Yuan Li, and T. T. Tjhung, “A novel iterative receiver for coded MIMO-OFDM systems,” in IEEE International Conference on Communications, vol. 4, pp. 2473-2477, 2004.

What is claimed is:

1. A method for determining a signal vector sent by a transmitter comprising a plurality of components from a received signal vector comprising
performing a QR decomposition of a channel matrix characterizing the communication channel via which the signal vector was received and being expanded by variance information about the noise on the communication channel
carrying out a plurality of determination steps using the QR decomposition of the expanded channel matrix, wherein in each step a set of possible sub-vectors of the signal vector is determined such that in each step, the number of possible sub-vectors in the set is lower than a predefined maximum number, wherein a possible sub-vector is a sub-vector of a signal vector that could have been sent by the transmitter and wherein in each step but the first step, each sub-vector of the set of sub-vectors is a sub-vector of the set of sub-vectors determined in the previous step expanded by one possible symbol for a component of the signal vector for which the sub-vectors in the previous sten do not comprise a possible symbol
selecting one vector of the set of possible sub-vectors determined in the last step of the plurality of determination steps as the signal vector.

2. The method according to claim 1, wherein the signal vector has been sent by a transmitter and the maximum number is lower than the number of all signal vectors that could be sent by the transmitter.

3. The method according to claim 2, wherein for each component of the signal vector a number of possible component values could be sent by the transmitter and where the predefined maximum number is lower than the number of possible component values to the power of the number of components of the signal vector.

4. The method according to claim 1, wherein all sub-vectors in a set of possible sub-vectors determined in a step have the same dimension.

5. The method according to 1, wherein the number of determination steps carried out is the number of components of the signal vector.

6. The method according to claim 1, wherein the signal vector is determined using a QRD-M algorithm based on the expanded channel matrix.

7. The method according to claim 1, further comprising pre-filtering the received signal vector using a MMSE filtering matrix.

8. The method according to claims 7, wherein the sets of sub-vectors are determined based on the pre-filtered received vector using a QRD-M algorithm.

9. The method according to claim 1, further comprising determining the minimum mean squared estimate for the signal vector and determining the signal vector based on the minimum mean squared estimate using a QRD-M algorithm.

10. The method according to claim 1, wherein in the first step of the plurality of determination steps, a set of possible symbols for a first component of the signal vector is determined.

11. (canceled)

12. (canceled)

13. (canceled)

14. The method according to claim 13, wherein the order of the components of the signal vector according to which the sub-vectors are expanded from step to step is based on the matrix R of the QR decomposition, the column norm or the row norm of the expanded channel matrix or based on V-BLAST ordering.

15. The method according to claim 1, wherein the signal vector is sent using a plurality of sending antennas and is received by a plurality of receiving antennas.

16. The method according to claim 15, wherein each component of the channel matrix characterizes the channel gain from one of the sending antennas to one of the receiving antennas.

17. A system for determining a signal vector sent by a transmitter and comprising a plurality of components from a received signal vector comprising
a decomposition circuit adapted to perform a QR decomposition of a channel matrix characterizing the communication channel via which the signal vector was received and being expanded by variance information about the noise on the communication channel
a determination circuit adapted to carry out a plurality of determination steps using the QR decomposition of the expanded channel matrix, wherein in each step a set of possible sub-vectors of the signal vector is determined such that in each step, the number of possible sub-vectors in the set is lower than a predefined maximum number, wherein a possible sub-vector is a sub-vector of a signal vector that could have been sent by the transmitter and wherein in each step but the first step. each sub-vector of the set of sub-vectors is a sub-vector of the set of sub-vectors determined in the previous step expanded by one possible symbol for a component of the signal vector for which the sub-vectors in the previous step do not comprise a possible symbol.
a selecting circuit adapted to select one vector of the set of possible sub-vectors determined in the last step of the plurality of determination steps as the signal vector.

18. Computer program element making a computer perform a a-method for determining a signal vector sent by a transmitter and comprising a plurality of components from a received signal vector comprising
performing a QR decomposition of a channel matrix characterizing the communication channel via which the signal vector was received and being expanded by variance information about the noise on the communication channel
carrying out a plurality of determination steps using the QR decomposition of the expanded channel matrix, wherein in each step a set of possible sub-vectors of the signal vector is determined and wherein in each step, the number of possible sub-vectors in the set is lower than a predefined maximum number, wherein a possible sub-vector is a sub-vector of a signal vector that could have been sent by the transmitter and wherein in each step but the first step. each sub-vector of the set of sub-vectors is a sub-vector of the set of sub-vectors determined in the previous step expanded by one possible symbol for a component of the signal vector for which the sub-vectors in the previous step do not comprise a possible symbol,
selecting one vector of the set of possible sub-vectors determined in the last step of the plurality of determination steps as the signal vector.
